(19) United States
(12) Patent Application Publication
(10) Pub. No.: US 2017/0304028 A1
(43) Pub. Date: Oct. 26, 2017

(54) PROSTHESIS FOR DENTAL REPLACEMENT, METHOD OF REDISTRIBUTING STRESS AND STRESS ANALYSIS METHOD

(71) Applicants: TAIPEI MEDICAL UNIVERSITY, Taipei City (TW); STEMBIOS TECHNOLOGIES, INC., Monterey Park, CA (US)

(72) Inventors: KENG-LIANG OU, TAIPEI CITY (TW); HAN-YI CHENG, TAIPEI CITY (TW); YUN YEN, TAIPEI CITY (TW)

(21) Appl. No.: 15/136,622

(22) Filed: Apr. 22, 2016

(51) Int. Cl. A61C 8/00; G01N 3/08

(52) U.S. Cl. CPC A61C 8/0086; G01N 3/08; A61C 8/0015; A61C 8/0048

(57) ABSTRACT

The present disclosure relates to a prosthesis for dental replacement, the prosthesis includes a root. The root includes an abutment and a base portion. The abutment is adapted for affixation of a dental crown thereto. The base portion is shaped for insertion into a tooth socket. The base portion includes a core, a metallic oxide layer on the core and a film-like stem cell layer on the metallic oxide layer. The metallic oxide layer has a number of holes.

### FIELD OF THE INVENTION

The invention relates to a prosthesis for dental replacement. Particularly, the invention provides a dental prosthesis with stem cells.

### BACKGROUND OF THE INVENTION

Stem cells derived from a human subject are potentially useful for a variety purposes, including regeneration of damaged tissues, reproduction, and as cellular models that could inform personal medicine, including diagnoses, treatments to alleviate a condition of disease or disorder, or warnings of adverse reaction to a potential treatment. Stem cell therapy has been pioneered extensively in regenerative and preventative treatments. Traditionally, the body will naturally replace wounded tissue with scar tissue and irregular vascular structure. However, with the help of stem cell therapy, it is possible that normal tissue can be formed after injury.

A dental implant is a load-bearing replacement that functions normally during masticatory activities and speech. Implant stability is the primary criterion for achieving the clinically successful restoration, which can be identified via invasive and noninvasive techniques. Resonance frequency analysis (RFA), a non-invasive and non-destructive quantitative measurement, has long been used to measure fluctuation in dental implant stability over time for clinically assessing implant integration. By this way, implant stability can be quantified by reading an implant stability quotient value (ISQ) using the Ossetell® mentor (Integration Diagnostics AB, Gothenburg, Sweden) (Bischof, M., et al., Implant stability measurement of delayed and immediately loaded implants during healing. Clinical Oral Implants Research, 2004. 15(5): p. 529-539). The ISQ, the stiffness, and the level of peri-implant bone are correlated; a higher ISQ means the better implant stability (Oates, T. W, et al., Enhanced implant stability with a chemically modified SLA surface: a randomized pilot study. International Journal of Oral & Maxillofacial Implants, 2007. 22(5)).

Osseointegration is a very important process of dental implantation. Titanium (Ti), either pure or alloyed, is an established component in various medical applications because of its corrosion resistance and outstanding mechanical performance. The surface characteristics of an implant plays an important role in the enhancement of osseointegration (Lin, Y.-K., et al., Effects of different extracellular matrices and growth factor immobilization on biodegradability and biocompatibility of macroporous bacterial cellulose. Journal of Bioactive and Compatible Polymers, 2011. 26(5): p. 508-518). Surface modified implants, which were accomplished by creating a rough surface texture or by altering the chemical composition, improved biological interactions with the implants and accelerated osseointegration. Recently, attention has been focused on a hybrid topography consisting of micropits and nanoporous TiO2 layers made via electrochemical oxidation to mimic the natural bony environment. Electrochemical oxidation resulted in increased wettability and the present chemical composition of standard SLA (sand-blasted, large-grit, acid-etched) surfaces and the surfaces promoted its biocompatibility were with high wettability and a thick TiO2 layer (SLAffinity) in the Ti-one 101 (Hung Chun Bio-S Co., Ltd, Taiwan) dental implants. Such hybrid micro-/nanostructures have proven to increase hydroxyapatite formation in vitro, enhance the proliferation and differentiation of osteoblasts, and improve local factor production (Gao, L., et al., Micro/nanostructural porous surface on titanium and bioactivity. Journal of Biomedical Materials Research Part B: Applied Biomaterials, 2009. 89(2): p. 335-341; Meng, W., et al., Effects of Hierarchical Micro/Nano-Textured Titanium Surface Features on Osteoblast-Specific Gene Expression. Implant dentistry, 2013. 22(6): p. 656-661). The in vitro studies noted above suggest that significant advantages exist for hybrid micro-/nanostructural Ti implants. However, clinical trial effects relative to the hybrid micro-/nanostructural Ti implants have not been elucidated.

### SUMMARY OF THE INVENTION

In accordance with some embodiments of the present disclosure, a prosthesis for dental replacement includes a root. The root includes an abutment and a base portion. The abutment is adapted for affixation of a dental crown thereto. The base portion is shaped for insertion into a tooth socket. The base portion includes a core, a metallic oxide layer on the core and a film-like stem cell layer on the metallic oxide layer. The metallic oxide layer has a number of holes.

In accordance with some embodiments of the present disclosure, a method of redistributing stress on a bone upon dental implantation, the method includes providing a root having a base portion including a core; forming a metallic oxide layer on the core; forming a number of holes in the metallic oxide layer; and forming a film-like stem cell layer on the metallic oxide layer.

In accordance with some embodiments of the present disclosure, a stress analysis method includes acquiring a first parameter associated with a porous layer of a dental implant; acquiring a second parameter associated with the porous layer of a dental implant; acquiring a third parameter associated with a film-like stem cell layer on the porous layer; and determining a stress in accordance with the first parameter, the second parameter and the third parameter.

### BRIEF DESCRIPTION OF THE DRAWING

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A, FIG. 1B and FIG. 1C show different views of a surface of the contour of the human maxilla. AVIZO (Internet Securities, Inc.) is used to detect the various boundary components of the maxilla.

FIG. 1A shows a sagittal view of a 3D FEA model.

FIG. 1B shows a transverse view of a 3D FEA model.

FIG. 1C shows a coronal view of a 3D FEA model.

FIG. 1D, FIG. 1E and FIG. 1F are clinical CT images show different views of a surface of the contour of the human maxilla.

FIG. 1D shows a sagittal view of a clinical CT image.

FIG. 1E shows a transverse view of a clinical CT image.

FIG. 1F shows a coronal view of a clinical CT image.

FIG. 2A shows a 3D Mesh model of an implant.

FIG. 2B shows a 3D Mesh model of an abutment.

FIG. 2C shows a 3D Mesh model of a disc.

FIG. 2D shows a 3D Mesh model of a dental crown.

FIG. 2E shows a 3D Mesh model of a maxilla.

FIG. 2F shows a 3D Mesh model of a mandible. The average numbers of nodes and elements in the models as shown in FIG. 2A, FIG. 2B, FIG. 2C, FIG. 2D, FIG. 2E and FIG. 2F are approximately 37,000 and 24,000.

FIG. 2G illustrates a cross-sectional view of an area of the base portion as shown in FIG. 2A.

FIG. 3A shows an SEM image of M-Ti surface tomography.

FIG. 3B shows an SEM image of SLA-Ti surface tomography.

FIG. 3C shows an SEM image of SLAffinity-Ti surface tomography. The SLAffinity-treated surface are subjected to SEM to evaluate the effect of SLAffinity on the microstructural variation of the implant surface.

FIG. 4 shows contact angle statistical analysis of M-Ti, SLA-Ti and SLAffinity-Ti. The untreated surfaces had the lower value (83.21±1.25), whereas SLAffinity-Ti surfaces exhibited a hydrophilic property in comparison, with a value of 65.14±1.35.

FIG. 5A shows stress distributions of SLAffinity-Ti and SLAffinity-Ti-SB in the implant or base portionat the 3-month model.

FIG. 5B shows the highest stress during 3 months. At all models, the maximum stresses varied from 325.15 to 428.60 MPa in implants. In the SLAffinity-Ti group, the stress of the implant at the first premolar position (428.60 MPa) was larger than that in the SLAffinity-Ti-SB group at 0-month, while the maximum stress in the SLAffinity-Ti group was 375.87 MPa.

FIG. 6A shows stress distributions of SLAffinity-Ti and SLAffinity-Ti-SB in the maxilla at the 3-month model.

FIG. 6B shows the highest stress during 3 months. The stresses of dental implant with SB cell therapy were less than that without SB cell therapy at 3-month. In the maxilla part, the highest von Mises stress was 37.47 MPa in the SLAffinity-Ti-SB group; these also decreased in the models with SB cell therapy. The stress patterns in both models are similar to each other.

FIG. 7A shows stress distributions of SLAffinity-Ti and SLAffinity-Ti-SB in the disc at the 3-month model.

FIG. 7B shows the highest stress during 3 months. The maximum observed von Mises stress occurred at the interface between the condyle and the disc, and the highest stresses of discs in the SLAffinity-Ti-SB group and the SLAffinity-Ti group were 12.97 and 13.87 MPa at 3 months, respectively.

FIG. 8 shows the HU analysis of SLAffinity-Ti and SLAffinity-Ti-SB in clinical trial during 3 months after surgery. Bone densities in HU at 3-month for the maxilla were 607.04, 594.78 and 546.28 in the SLAffinity-Ti-SB-1, SLAffinity-Ti-SB-2 and SLAffinity-Ti implants.

### DETAILED DESCRIPTION OF THE INVENTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In one aspect, the invention provides a prosthesis for dental replacement, the prosthesis comprising: a root comprising an abutment adapted for affixation of a dental crown thereto; and a base portion shaped for insertion into a tooth socket, the base portion comprising a core, a metallic oxide layer on the core, the metallic oxide layer having a number of holes, and a film-like stem cell layer on the metallic oxide layer.

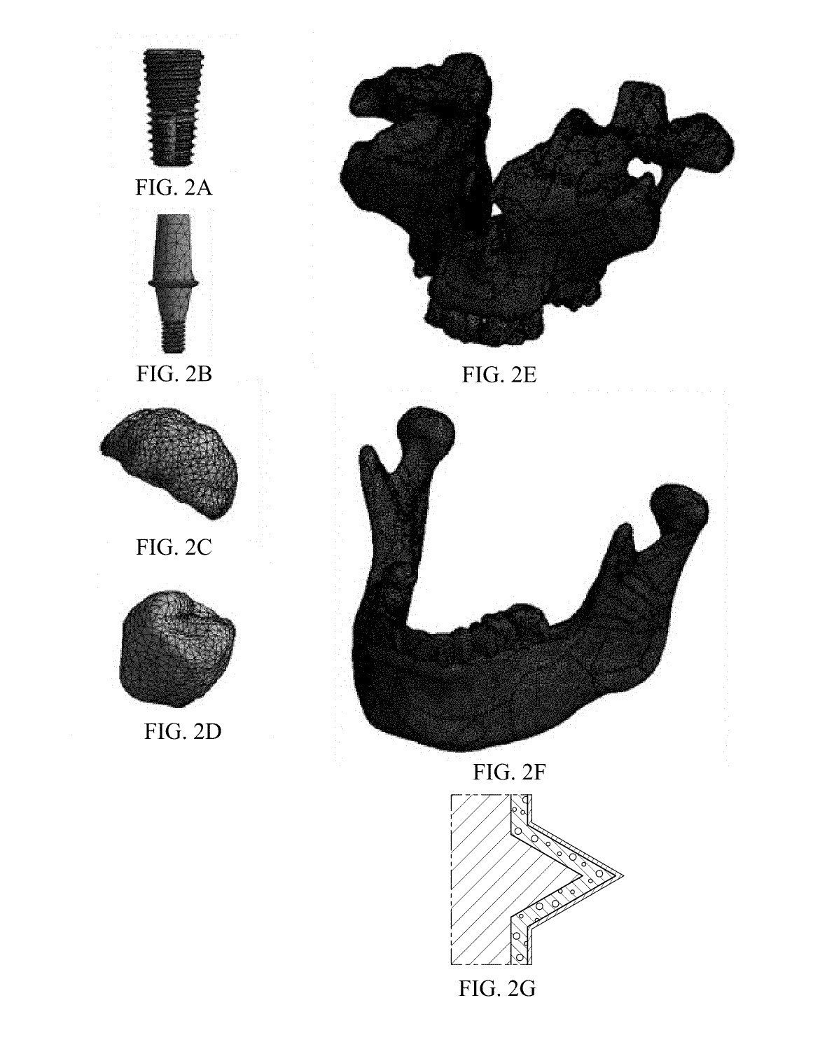

Referring to FIG. 2A, which shows 3D Mesh models of an implant 21 or base portion 21 of a root of a prosthesis for dental replacement.

Referring to FIG. 2B, which shows 3D Mesh models of abutment 22 of a root of a prosthesis for dental replacement.

Referring to FIGS. 2A and 2B, the prosthesis for dental replacement may include a root 21, 22. The root 21, 22 includes a base portion 21 and an abutment 22. The abutment 22 is adapted for affixation of a dental crown 23 (shown in FIG. 2 (d)) thereto. The base portion 21 is shaped for insertion into a tooth socket.

Referring to FIG. 2C, which shows 3D Mesh models of a disc (not denoted).

Referring to FIG. 2D, which shows 3D Mesh models of a dental crown 23 of a prosthesis for dental replacement.

Referring to FIG. 2E, which shows 3D Mesh models of an exemplary maxilla.

Referring to FIG. 2F, which shows 3D Mesh models of an exemplary mandible. The average numbers of nodes and elements in the above models are approximately 37,000 and 24,000.

FIG. 2G illustrates a cross-sectional view of an area “A” (circled by dotted line) of the base portion 21 as shown in FIG. 2A. Referring to FIG. 2G, the base portion 21 includes a core 211, a metallic oxide layer 212 on the core 211 and a film-like stem cell layer 213 on the metallic oxide layer 212. The metallic oxide layer 212 has a number of holes 212h.

In some embodiments, each of the number of holes 212h in the metallic oxide layer 212 has a width of approximately 500 nanometers. In one embodiment, the metallic oxide layer 212 has a first thickness, wherein tensile stress on a bone upon implantation is proportional to the first thickness. In another embodiment, the film-like stem cell layer 213 has a second thickness, wherein tensile stress on a bone upon implantation is proportional to the second thickness. In a further embodiment, the tensile stress on a bone upon implantation is inversely proportional to a porosity of the metallic oxide layer 212. Preferably, the tensile stress (σi) on a bone is determined by the following equation:

$${σ}_{i} = 200 + \frac{1}{4} {E}_{0} [ \frac{1}{2} + \frac{{τ}_{i}}{200 {T}_{c}} + {Σ}_{i = 1}^{∞} \frac{{T}_{sc - i}}{200 {T}_{c}} + \frac{1}{2} {( 1 - ρ i )}^{2} ]$$

wherein E₀ is a modulus of elasticity of the metallic oxide layer prior to a formation of the number of holes, T₀ is a thickness of the metallic oxide layer prior to a formation of the number of holes, Tᵢ is a thickness of the metallic oxide layer, T_{sc-i} is a thickness of the film-like stem cell layer, pi is porosity of the metallic oxide layer.

In another aspect, the invention provides a method of redistributing stress on a bone upon dental implantation, the method comprising: providing a root 21, 22 having a base portion 21 including a core 211; forming a metallic oxide layer 212 on the core 211; forming a number of holes 212h in the metallic oxide layer 212; and forming a film-like stem cell layer 213 on the metallic oxide layer 212.

In another aspect, the invention provides a stress analysis method, comprising: acquiring a first parameter associated with a porous layer 212 of a dental implant; acquiring a third parameter associated with a film-like stem cell layer 213 on the porous layer 212; and determining a stress in accordance with the first parameter, the second parameter and the third parameter.

In one embodiment, the first parameter is a thickness of the porous layer 212. In one embodiment, the second parameter is a porosity of the porous layer. In another embodiment, the third parameter is a thickness of the film-like stem cell layer 213. In a further embodiment, the stress is proportional to the first parameter; the stress is inversely proportional to the second parameter or the stress is proportional to the third parameter. In a more further embodiment, the stress (σᵢ) is determined by the following equation:

$${σ}_{i} = 200 + \frac{1}{4} {E}_{0} [ \frac{1}{2} + \frac{{τ}_{i}}{200 {T}_{c}} + {Σ}_{i = 1}^{∞} \frac{{T}_{sc - i}}{200 {T}_{c}} + \frac{1}{2} {( 1 - ρ i )}^{2} ]$$

wherein E₀ is a modulus of elasticity of the metallic oxide layer prior to a formation of the number of holes, T₀ is a thickness of the metallic oxide layer prior to a formation of the number of holes, Tᵢ is the first parameter, T_{sc-i} is the third parameter, ρi is the second parameter.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The aim of the present study is to present the results obtained from SLAffinity implantation in conjunction with SB cell therapy in the maxilla. Clinical and radiographic data were collected during the 3 months after surgery.

### EXAMPLES

### Example 1 Purification of SB Cells

Peripheral blood from each patient is drawn and collected in anticoagulant tubes. The blood is then processed by StemBios Technologies Inc. with its proprietary method to create a mixture of SB cells. These cells were then resuspended in DPBS with final concentration of 1×10⁶ to 1×10⁷ SB cells/mL.

To characterize the SB mixture, the cells were analyzed using flow cytometry. The size of SB cells, as confirmed by flow cytometry, was smaller than 6 micrometers. In addition to size, the SB mixture was investigated for the presence of similar small stem cells, blastomere-like stem cells (B LSCs) and very-small embryonic-like stem cells (VSELs), using the CD66e and CD133 markers, respectively. CD66e and CD133 were used to ensure the absences of BLSCs and VSELs in the SB mixture. The result demonstrated less than 1% of the cells in the SB mixture expressed either CD66e or CD133, suggesting that the VSEL and BLSC concentrations in this mixture were insignificant. So the SB mixture administered was comprised solely of functional SB cells as the platelets are inactivated and B L SC and VSEL populations are negligible. SB cell concentration was around 1×10⁶ to 1×107 SB cells/mL when injected.

### Example 2 Properties Evaluation of the SLAffinity-Treated Surface

The scanning electron microscopy (SEM; JEOL JSM-6500F) was employed to analyze the surface morphologies of the SLAffinity-treated samples. Moreover, wettability examinations were performed using the sessile drop method using a GBX DGD-DI contact angle goniometer. Liquid deionized water was adopted in the test. Contact angle measurements were measured using at least five drops for each sample in order to obtain statistical averages.

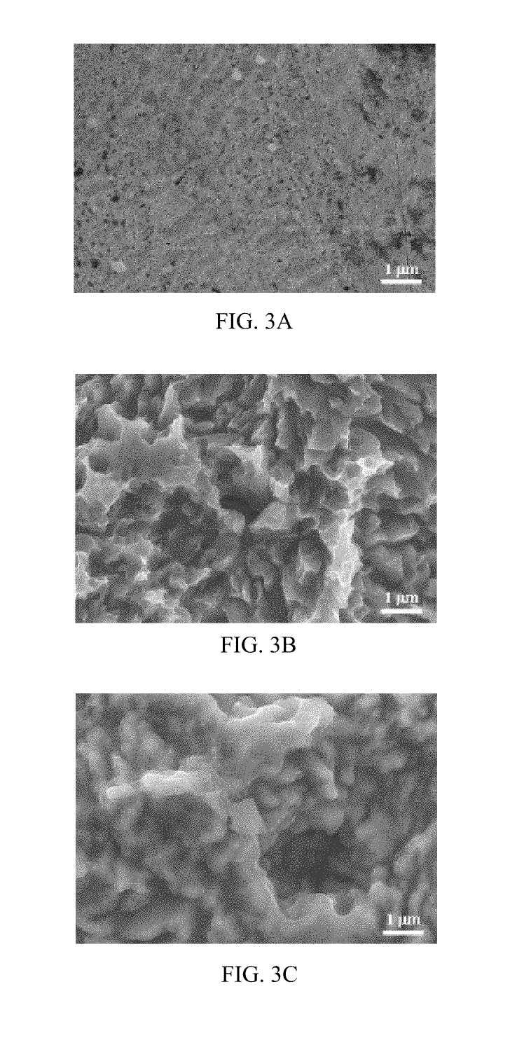

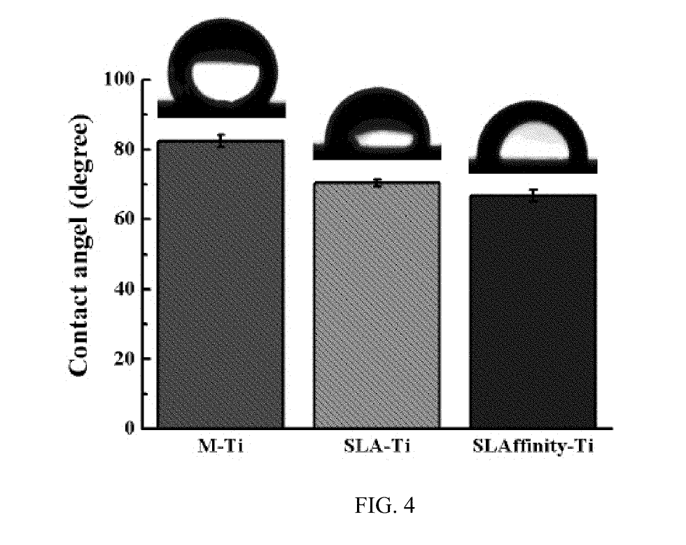

The SLAffinity-treated surfaces are subjected to SEM to evaluate the effect of SLAffinity on the microstructural variation of the implant surface as shown in FIG. 3C. The SEM showed a homogenous and porous surface with nanoholes as depicted in FIG. 3C, where the average diameter of the nanoholes is approximately 500 nm. The contact angles of distilled water on SLAffinity-Ti and untreated surfaces were examined. The untreated surfaces had the lower value (83.21±1.25), whereas SLAffinity-Ti surfaces exhibited a hydrophilic property in comparison, with a value of 65.14±1.35 as shown in FIG. 4. ANOVA revealed a significant difference between the SS and three nanostructured surface samples (p<0.05).

### Example 3 Finite Element Analysis

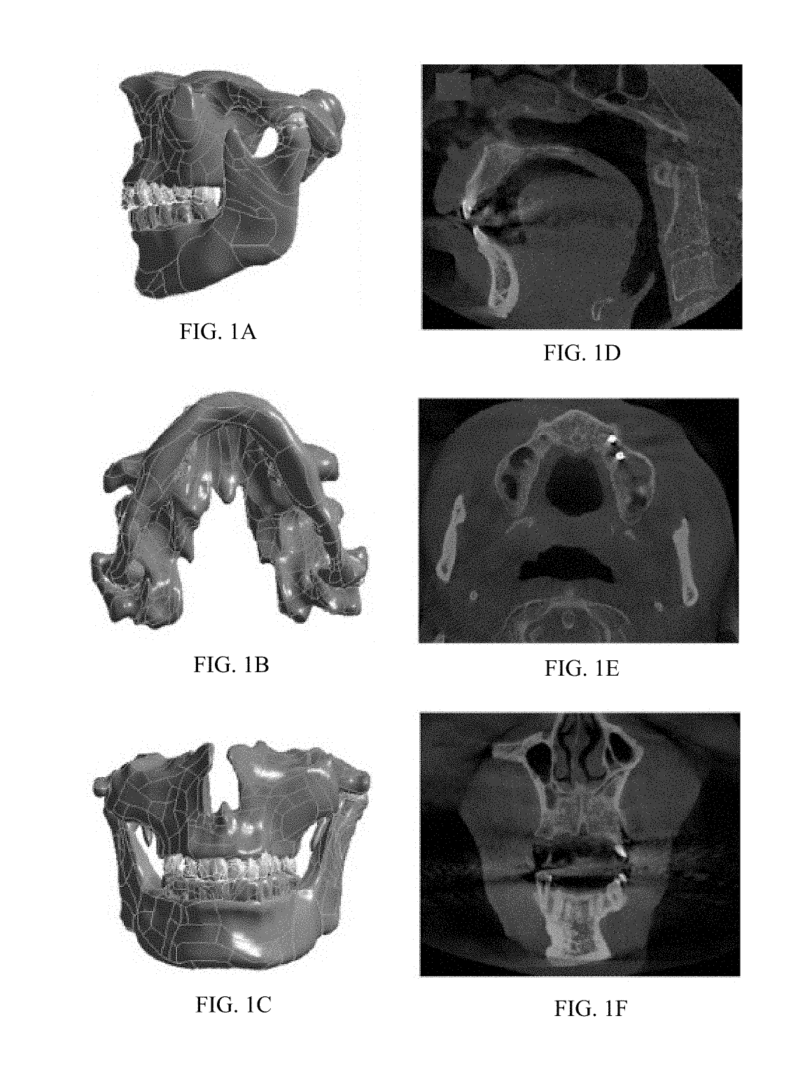

A 3D maxilla model was rebuilt using computed tomography (CT, Light Speed, GE) images as shown in FIG. 1A, FIG. 1B, FIG. 1C, FIG. 1D, FIG. 1E and FIG. 1F. A set of images was derived to describe the surface of the contour of the human maxilla. AVIZO (Internet Securities, Inc.) was used to detect the various boundary components of the maxilla. The biomechanical properties of the cortical bone, cancellous bone, and titanium have been described previously (Olaya, J. J., et al., Comparative study of chromium nitride coatings deposited by unbalanced and balanced magnetron sputtering. Thin Solid Films, 2005. 474(1-2): p. 119-126; dos Santos, I., et al., Effect of variable heat transfer coefficient on tissue temperature next to a large vessel during radiofrequency tumor ablation. BioMedical Engineering OnLine, 2008. 7(1): p. 21; Savvides, N. and T. J. Bell, Hardness and elastic modulus of diamond and diamond-like carbon films. Thin Solid Films, 1993. 228(1-2): p. 289-292; and Ledbetter, H. M., N. V. Frederick, and M. W. Austin, Elastic&#x2010; constant variability in stainless&#x2010; steel 304. Journal of Applied Physics, 1980. 51(1): p. 305-309). The 3D maxilla models were simulated using the ANSYS Workbench 12.1 (ANSYS, Inc.) program. Converging and reinforcing processes are important to obtain an accurate mesh model for FEA, as they allow the 3D model to more accurately represent the actual object. The average numbers of nodes and elements in the models are approximately 37,000 and 24,000, respectively as shown in FIG. 2A, FIG. 2B, FIG. 2C, FIG. 2D, FIG. 2E and FIG. 2F. In the part of boundary conditions, it considered the three muscles that are involved in mouth closure. The direction and magnitude of the muscle forces were taken from our previous studies (Chu, K.-T., et al., Enhancement of biomechanical behavior on osseointegration of implant with SLAffinity. Journal of Biomedical Materials Research Part A, 2013. 101A(4): p. 1195-1200); it was necessary to determine the cross-sectional area (CSA) and calculate the maximum muscle force via the following mathematical function. The muscle forces (left side/right side) were as follows: masseter (176.86 N/161.32 N), temporal is (104.71 N/125.80 N), and medial pterygoid (87.69 N/79.18 N).

The Young's modulus of the SLAffinity layer was 43.65 GPa, determined using a TriboLab nanoindenter (Hysitron) with a diamond indenter (tip radius: 150 nm). In the present study, the stress distributions of SLAffinity-treated dental implants with SB cell therapy (SLAffinity-Ti-SB) model and without SB cell model (SLAffinity-Ti) were compared.

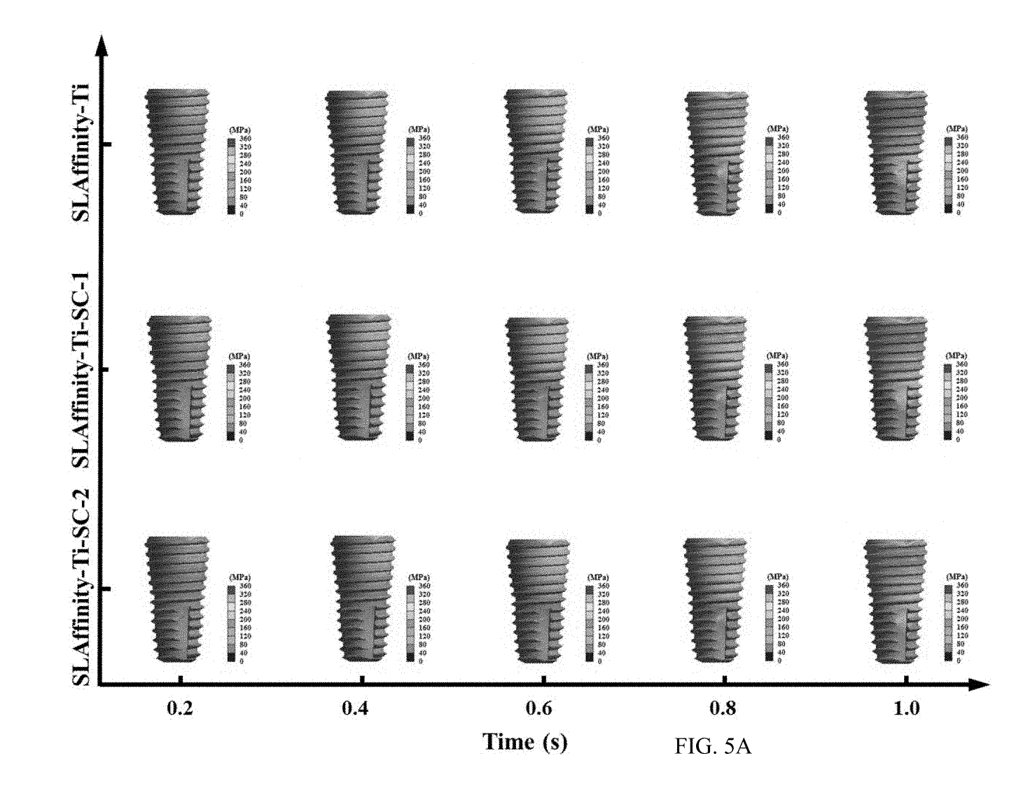

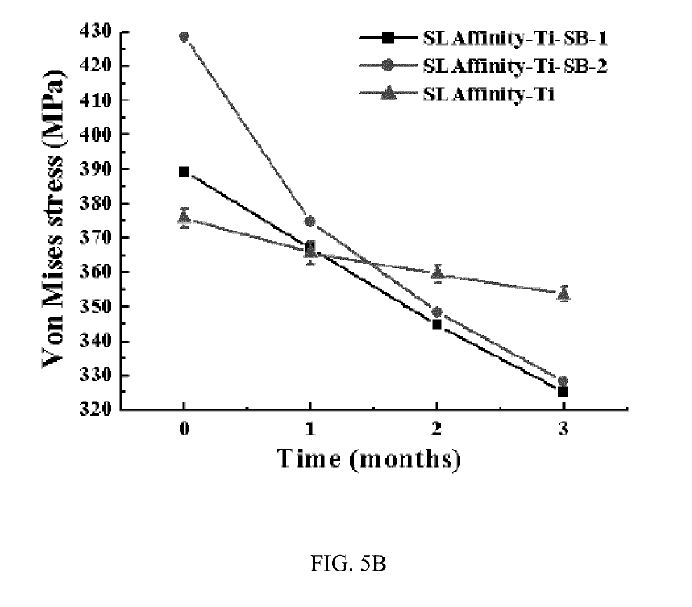

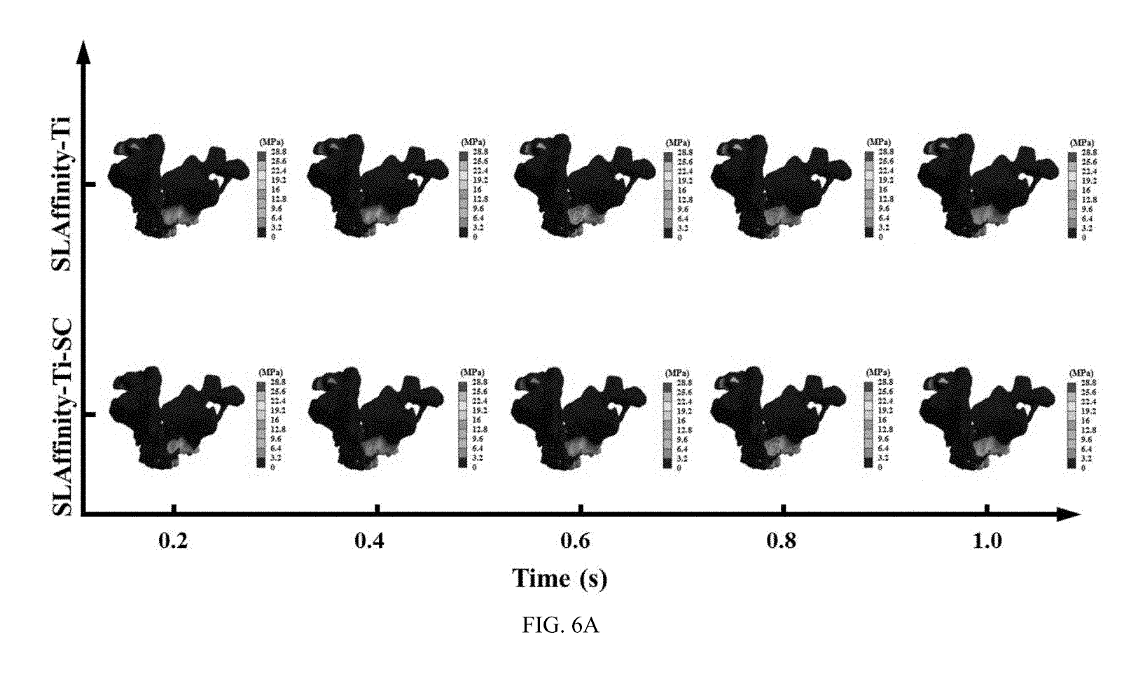

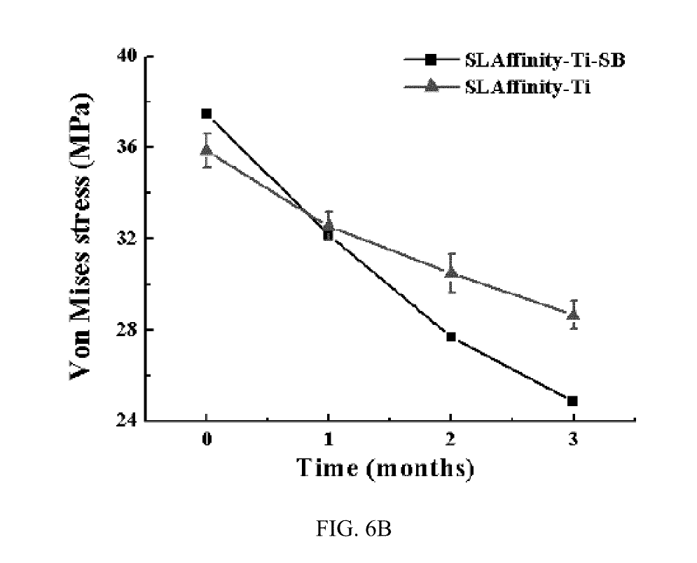

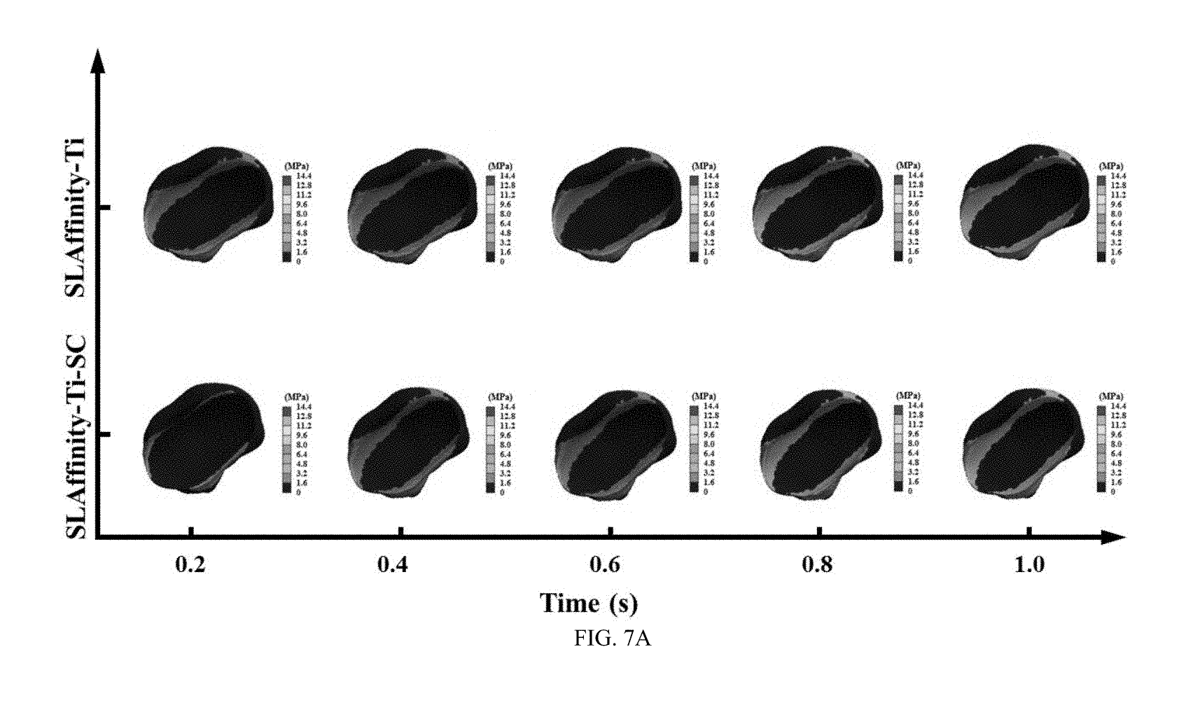

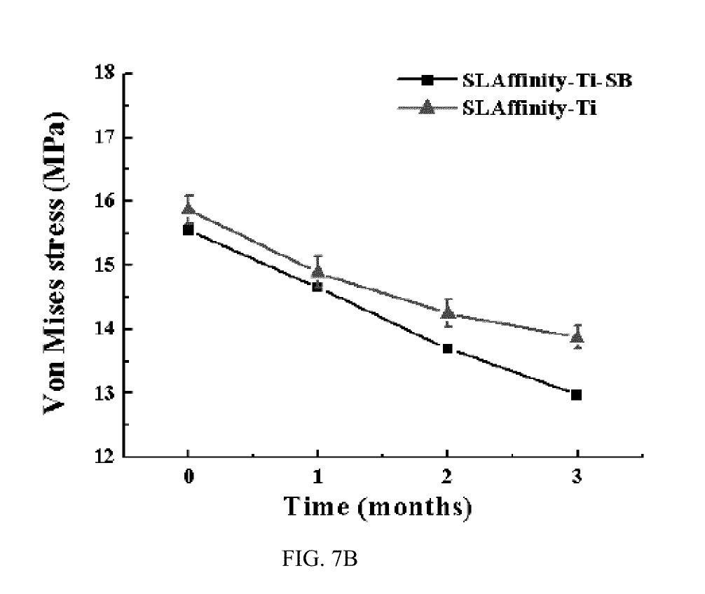

FIG. 5A and FIG. 5B show the stress distributions for SLAffinity-Ti-SB and SLAffinity-Ti models in the maxilla after treatment for 3 months. At all models, the maximum stresses varied from 325.15 to 428.60 MPa in implants. In the SLAffinity-Ti group, the stress of the implant at the first premolar position (428.60 MPa) was larger than that in the SLAffinity-Ti-SB group at 0-month, while the maximum stress in the SLAffinity-Ti group was 375.87 MPa. The stresses of dental implant with SB cell therapy were less than that without SB cell therapy at 3-month. In the maxilla part, the highest von Mises stress was 37.47 MPa in the SLAffinity-Ti-SB group; these also decreased in the models with SB cell therapy. The stress patterns in both models were similar to each other as shown in FIG. 6A, FIG. 6B, FIG. 7A and FIG. 7B. FIG. 7A and FIG. 7B show the stress distributions of the discs. The maximum observed von Mises stress occurred at the interface between the condyle and the disc, and the highest stresses of discs in the SLAffinity-Ti-SB group and the SLAffinity-Ti group were 12.97 and 13.87 MPa at 3 months, respectively. In contrast, stresses of mandible, abutment and prosthesis demonstrated no significant differences between the two groups as shown in Table 1. Analysis of the present data indicated that stresses were transferred more uniformly in the models that received SB cell therapy combined with SLAffinity-treated implants.

TABLE 1
Von Mises stresses in all elements (MPa). Analysis of the present data
indicated that stresses were transferred more uniformly in the models that
received SB cell therapy combined with SLAffinity-treated implants.

| Element | Group | 0-month | 1-month | 2-month | 3-month |
|---|---|---|---|---|---|
| Implant | SLAffinity-Ti | 375.87 | 365.74 | 359.57 | 353.69 |
| | SLAffinity-Ti-SB-1 | 389.47 | 367.10 | 344.69 | 325.15 |
| | SLAffinity-Ti-SB-2 | 428.60 | 374.91 | 348.44 | 328.36 |
| Abutment | SLAffinity-Ti | 307.47 | 303.47 | 299.74 | 291.57 |
| | SLAffinity-Ti-SB-1 | 313.99 | 301.07 | 292.35 | 284.36 |
| | SLAffinity-Ti-SB-2 | 317.12 | 301.84 | 293.45 | 284.77 |
| Mandible | SLAffinity-Ti | 37.45 | 36.47 | 35.78 | 35.17 |
| | SLAffinity-Ti-SB | 37.68 | 36.14 | 35.10 | 34.92 |
| Maxilla | SLAffinity-Ti | 35.87 | 32.54 | 30.47 | 28.65 |
| | SLAffinity-Ti-SB | 37.47 | 32.14 | 27.69 | 24.85 |
| Disc | SLAffinity-Ti | 15.87 | 14.89 | 14.25 | 13.87 |
| | SLAffinity-Ti-SB | 15.54 | 14.65 | 13.70 | 12.97 |
| Prosthesis | SLAffinity-Ti | 133.47 | 131.55 | 128.36 | 124.36 |
| | SLAffinity-Ti-SB-1 | 134.87 | 129.44 | 124.38 | 121.61 |
| | SLAffinity-Ti-SB-2 | 135.94 | 130.92 | 125.45 | 122.33 |

### Example 4 Clinical Trial

Eleven volunteers with an average age of 41.74±9.14 years, were enrolled in the present clinical trial. All the volunteers were in good health, with no systemic disorders. All were accurately informed about the procedures, and signed the informed consent form. This study has been approved by the Ethics Committee at the Taipei Medical University (Taipei, Taiwan) according to Institutional Review Board (IRB) application. Ten patients received one SLAffinity-treated implant in the maxilla in the posterior area, and one patient with low bone tissue density received two SLAffinity-treated implant (SLAffinity-Ti) with SB cell therapy at the region of the first (SLAffinity-Ti-SB-1) and the second (SLAffinity-Ti-SB-2) premolars. The patients underwent a complete surgical and prosthodontic diagnostic evaluation for implant treatment and a surgical template was fabricated. A total amount of 12 these implants were proceed. Computed tomography (Light Speed, GE) scan was performed as diagnostic purpose. An image-based bone density classification utilizing radiodensity through CT has been proposed (Todisco, M. and P. Trisi, Bone mineral density and bone histomorphometry are statistically related. International Journal of Oral & Maxillofacial Implants, 2005. 20(6)). CT attenuation coefficient expressed in Hounsfield units (HU) provided the objective data to describe the bone quality (Todisco, M. and P. Trisi, Bone mineral density and bone histomorphometry are statistically related. International Journal of Oral & Maxillofacial Implants, 2005. 20(6)). HU numbers were then recorded at surgery day as baseline and after surgery of 3 months.

Under localized anesthesia, a crestal incision and a full-thickness flap elevation were performed. The pilot drill, 2.3 mm in external diameter, was used to drill into the scheduled bone depth with a continuous saline infusion. The surgical site, following a manufacture's drilling protocol, was performed for placement for 4.0- or 4.5-mm diameter implants. Implants were hand-tightened into suggested implant-bone level position. A transmucosal cover screw was attached to the implant and soft tissues were recovered and sutured. Sutures were removed 7 days after surgery. CT scans were performed at the following 3 months. Patients were constantly monitored until the final prosthetic reconstruction.

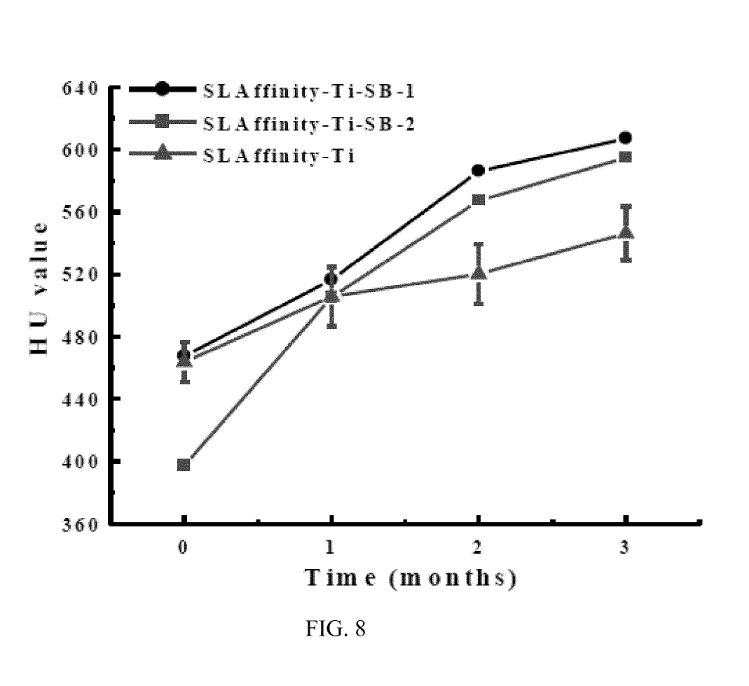

Successful implant treatments of 11 cases were found throughout 3 months. Patients had no special pain or any discomfort after implant treatment. Bone healing was evaluated by CT images and HU analysis. SLAffinity-Ti implants showed a 100% success rate at the end of the follow-up period. Bone densities in HU at 3-month for the maxilla were 607.04, 594.78 and 546.28 in the SLAffinity-Ti-SB-1, SLAffinity-Ti-SB-2 and SLAffinity-Ti implants as shown in FIG. 8. It was found that the mean bone densities of 3-month groups with SB cell therapy were significantly higher than those without SB cell therapy (p<0.05). The mean ISQ at the baseline for all implants was 75.5±8.2 at 3-month, and the values obtained are represented in Table 2. The rapid increase of ISQ was discovered while monitoring the low density bone tissue that underwent SB cell therapy.

TABLE 2
Mean ISQ obtained at the baseline, 1- and 3-month. The rapid increase of
ISQ was discovered while monitoring the low density bone tissue that
underwent SB cell therapy.

| | | | 3-month |
|---|---|---|---|
| Group | Baseline | 1-month post-surgery | post-surgery |
| SLAffinity-Ti | 69.7 ± 8.6 | 71.7 ± 9.3 | 74.8 ± 8.0 |
| (n = 10) | | | |
| SLAffinity-Ti-SB- | 82 | 76 | 80 |
| SLAffinity-Ti-SB- | 46 | 75 | 78 |
| Total | 68.8 ± 8.9 | 72.3 ± 9.4 | 75.5 ± 8.2 |

Data were expressed as mean±standard error of the mean. Data were analyzed using analysis of variance (ANOVA). All statistical analyses were performed using SPSS version 12.0 (SPSS, Inc, Chicago, Ill., USA). Values of p<0.05 were considered significant.

What is claimed is:

1. A prosthesis for dental replacement, the prosthesis comprising:
a root comprising:
an abutment adapted for affixation of a dental crown thereto; and
a base portion shaped for insertion into a tooth socket, the base portion comprising:
a core;
a metallic oxide layer on the core, the metallic oxide layer having a number of holes; and
a film-like stem cell layer on the metallic oxide layer.

2. The prosthesis of claim 1, wherein each of the number of holes has a width of approximately 500 nanometers.

3. The prosthesis of claim 1, wherein the metallic oxide layer has a first thickness, wherein tensile stress on a bone upon implantation is proportional to the first thickness.

4. The prosthesis of claim 1, wherein the film-like stem cell layer has a second thickness, wherein tensile stress on a bone upon implantation is proportional to the second thickness.

5. The prosthesis of claim 1, wherein tensile stress on a bone upon implantation is inversely proportional to a porosity of the metallic oxide layer.

6. The prosthesis of claim 1, wherein tensile stress (σᵢ) on a bone is determined by the following equation:
$${σ}_{i} = 200 + \frac{1}{4} {E}_{0} [ \frac{1}{2} + \frac{{τ}_{i}}{200 {T}_{c}} + {Σ}_{i = 1}^{∞} \frac{{T}_{sc - i}}{200 {T}_{c}} + \frac{1}{2} {( 1 - ρ i )}^{2} ]$$
wherein E₀ is a modulus of elasticity of the metallic oxide layer prior to a formation of the number of holes, T₀ is a thickness of the metallic oxide layer prior to a formation of the number of holes, Tᵢ is a thickness of the metallic oxide layer, T_{sc-i} is a thickness of the film-like stem cell layer, ρi is porosity of the metallic oxide layer.

7. A method of redistributing stress on a bone upon dental implantation, the method comprising:
providing a root having a base portion including a core;
forming a metallic oxide layer on the core;
forming a number of holes in the metallic oxide layer; and
forming a film-like stem cell layer on the metallic oxide layer.

8. The method of claim 7, wherein each of the number of holes has a width of approximately 500 nanometers.

9. The method of claim 7, wherein the metallic oxide layer has a first thickness, wherein tensile stress on a bone upon implantation is proportional to the first thickness.

10. The method of claim 7, wherein the film-like stem cell layer has a second thickness, wherein tensile stress on a bone upon implantation is proportional to the second thickness.

11. The method of claim 7, wherein tensile stress on a bone upon implantation is inversely proportional to a porosity of the metallic oxide layer.

12. The method of claim 7, wherein tensile stress (σᵢ) on a bone is determined by the following equation:
$${σ}_{i} = 200 + \frac{1}{4} {E}_{0} [ \frac{1}{2} + \frac{{τ}_{i}}{200 {T}_{c}} + {Σ}_{i = 1}^{∞} \frac{{T}_{sc - i}}{200 {T}_{c}} + \frac{1}{2} {( 1 - ρ i )}^{2} ]$$
wherein E₀ is a modulus of elasticity of the metallic oxide layer prior to a formation of the number of holes, T₀ is a thickness of the metallic oxide layer prior to a formation of the number of holes, Tᵢ is a thickness of the metallic oxide layer, T_{sc-i} is a thickness of the film-like stem cell layer, ρi is porosity of the metallic oxide layer.

13. A stress analysis method, comprising:
acquiring a first parameter associated with a porous layer of a dental implant;
acquiring a second parameter associated with the porous layer of a dental implant;
acquiring a third parameter associated with a film-like stem cell layer on the porous layer; and
determining a stress in accordance with the first parameter, the second parameter and the third parameter.

14. The method of claim 13, wherein the first parameter is a thickness of the porous layer.

15. The method of claim 13, wherein the second parameter is a porosity of the porous layer.

16. The method of claim 13, wherein the third parameter is a thickness of the film-like stem cell layer.

17. The method of claim 13, wherein the stress is proportional to the first parameter.

18. The method of claim 13, wherein the stress is inversely proportional to the second parameter.

19. The method of claim 13, wherein the stress is proportional to the third parameter.

20. The method of claim 13, wherein the stress (σᵢ) is determined by the following equation:
$${σ}_{i} = 200 + \frac{1}{4} {E}_{0} [ \frac{1}{2} + \frac{{τ}_{i}}{200 {T}_{c}} + {Σ}_{i = 1}^{∞} \frac{{T}_{sc - i}}{200 {T}_{c}} + \frac{1}{2} {( 1 - ρ i )}^{2} ]$$
wherein E₀ is a modulus of elasticity of the metallic oxide layer prior to a formation of the number of holes, T₀ is a thickness of the metallic oxide layer prior to a formation of the number of holes, Tᵢ is the first parameter, T_{sc-i} is the third parameter, ρi is the second parameter.
